(19) United States
(12) Patent Application Publication
(10) Pub. No.: US 2024/0151970 A1
(43) Pub. Date: May 9, 2024

(54) HEAD MOUNTED DISPLAY

(71) Applicant: Hitachi-LG Data Storage, Inc., Tokyo (JP)

(72) Inventors: Toshiteru NAKAMURA, Tokyo (JP); Takuma KUNO, Tokyo (JP); Takahiro MOURI, Tokyo (JP)

(21) Appl. No.: 18/039,309

(22) PCT Filed: Dec. 27, 2021
(86) PCT No.: PCT/JP2021/048706

§ 371 Date: May 30, 2023

(30) Foreign Application Priority Data
Feb. 18, 2021 (JP) 2021-024673

(51) Int. Cl. G02B 27/01

(52) U.S. Cl. CPC G02B 27/017; G02B 2027/0178

(57) ABSTRACT

A head mounted display displays an image in the user's field of vision and includes a video display unit that generates the image to be displayed. A first waveguide and a second waveguide duplicate the video light from the video display unit. Each of the waveguides includes a pair of parallel main planes that confine video light by internal reflection. The first waveguide includes an incident surface that reflects video light into the inside and two or more outgoing reflective surfaces emit video light into the second waveguide. The second waveguide includes an input unit that couples video light from the first waveguide to the inside and an output unit that emits video light to the user's pupil, wherein the angle between the duplication direction of video light in the first waveguide and the duplication direction of video light in the second waveguide is less than 90°.

### BACKGROUND OF THE INVENTION

### Field of the Invention

This invention relates to a head mounted display that is worn on the user's head and displays image in the field of view.

### Description of the Related Art

Wearable devices such as head mounted display (hereinafter referred to as HMD) require not only display performance, such as good vision and visibility of images, but also a compact structure with excellent wearability.

A prior art document in the field of this technique is JP-A-2003-536102, which discloses an optical device comprising a flat substrate that allows light to pass through, optical means for coupling light into the substrate by means of an internal reflective whole, and a plurality of partially reflective surfaces possessed by the substrate, wherein the partially reflective surfaces are parallel to each other and not parallel for any edge of the substrate.

The optical system of an HMD has an image display unit equipped with an illumination unit that transmits light emitted by the light source unit to a small display unit, and a projection unit that projects the image light (imaginary image) generated by the image display unit. If the HMD is misaligned with the user's eyes, the screen will be cut off. Therefore, for example, the eye box can be enlarged by using a waveguide that constitutes the duplication unit. However, the eye box enlargement causes the optical system size to increase and the optical efficiency to decrease.

In the above JP-A-2003-536102, no consideration was given to these issues in balancing the eye box expansion of the optical system and the miniaturization of the HMD optical system.

The purpose of the present invention is to provide HMD that combine miniaturization of the optical system with expansion of the eye box.

### SUMMARY OF THE INVENTION

The present invention, to give an example, is a head mounted display that displays image in the user's field of vision, includes a video display unit that generates the image to be displayed, a first waveguide and a second waveguide that duplicate the video light from the video display unit. each of the first waveguide and the second waveguide includes a pair of parallel main planes that confine video light by internal reflection, the first waveguide includes an incident surface that reflects video light into the inside and two or more outgoing reflective surfaces that emit video light into the second waveguide, the second waveguide includes an input unit that couples video light from the first waveguide to the inside and an output unit that emits video light to the user's pupil. The angle between the duplication direction of video light in the first waveguide and the duplication direction of video light in the second waveguide is less than 90°.

### Advantageous Effect

The present invention can provide HMD that combine miniaturization of the optical system with expansion of the eye box.

### BRIEF DESCRIPTION OF THE DRAWINGS

FIG. 1A is a block diagram of the HMD in Example 1.

FIG. 1B shows an example of the hardware configuration of the HMD shown in FIG. 1A.

FIG. 2 is a block diagram of the virtual image generation unit in Example 1.

FIG. 3 is a diagram of the HMD form of usage in Example 1.

FIG. 4A is a diagram of a conventional virtual image generation unit.

FIG. 4B is a diagram of a conventional virtual image generation unit.

FIG. 5A is a diagram of the first and second waveguides in Example 1.

FIG. 5B is a diagram of the first and second waveguides in Example 1.

FIG. 6 is a comparative configuration diagram of the video light duplication unit without light confining and the first waveguide in Example 1.

FIG. 7 is a schematic diagram showing light ray propagation in the first waveguide in Example 1.

FIG. 8A is a variation of the first and second waveguide in Example 1.

FIG. 8B is a variation of the first and second waveguide in Example 1.

FIG. 9 is a schematic diagram of the technical issues of the first waveguide in Example 1.

FIG. 10A is a diagram of the first and second waveguides in Example 2.

FIG. 10B is a diagram of the first and second waveguides in Example 2.

FIG. 11A is a diagram of a variation of the first and second waveguide in Example 2.

FIG. 11B is a diagram of a variation of the first and second waveguide in Example 2.

FIG. 12 is a schematic diagram showing the light path of the backside reflection.

FIG. 13 is an example of configuration diagram of the first and second waveguide.

FIG. 14 shows an example of the use of the HMD in Example 3.

FIG. 15 is a block diagram of the HMD in Example 3.

### MODE FOR CARRYING OUT THE INVENTION

Following, embodiments of the present invention will be described with reference to the drawings. The following description and drawings are illustrative examples to explain the invention, and have been omitted or simplified as appropriate for clarity of explanation. The invention can also be implemented in various other forms. Unless otherwise limited, each component can be singular or plural.

The position, size, shape, extent, etc. of each component shown in the drawings may not represent the actual position, in order to facilitate understanding of the invention. Therefore, the invention is not necessarily limited to the position, size, shape, range, etc. disclosed in the drawings.

In the following explanations, various types of information may be described in terms of “tables,” “lists,” etc., but various types of information may be expressed in data structures other than these. XX table”, “XX list”, etc. may be called “XX information” to indicate that they do not depend on any data structure. When expressions such as “identification information,” “identifier,” “name,” “ID,” “number,” etc. are used when describing identification information, they can be substituted for each other.

When there are multiple components having the same or similar functions, the same numerals may be explained with different subscripts. However, when there is no need to distinguish between these multiple components, the subscripts may be omitted and explain.

In the following description, the processing performed by executing the program may be described, but the program is executed by the processor (e.g., CPU (Central Processing Unit), GPU (Graphics Processing Unit)) to perform prescribed processing while appropriately using storage resources (e.g., memory) and/or interface devices (e.g., communication ports). Therefore, the subject of processing may be the processor. Similarly, the subject of the processing performed by executing the program may be a controller, device, system, computer, or node having a processor. The processing subject that executes the program may be a processing unit, or it may be a dedicated circuit (e.g., FPGA (Field-Programmable Gate Array) or ASIC (Application Specific Integrated Circuit)) that performs specific processing.

The program may be installed on a device such as a computer from a program source. The program source may be, for example, a program distribution server or computer readable storage media. If the program source is a program distribution server, the program distribution server may include a processor and a storage resource that stores the program to be distributed, and the processor of the program distribution server may distribute the program to other computers. In the following description, two or more programs may be realized as one program, or one program may be realized as two or more programs.

### Example 1

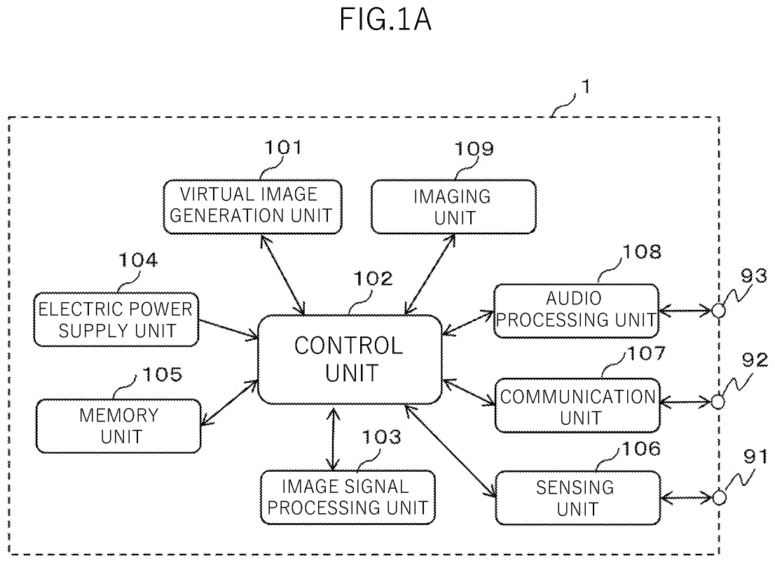

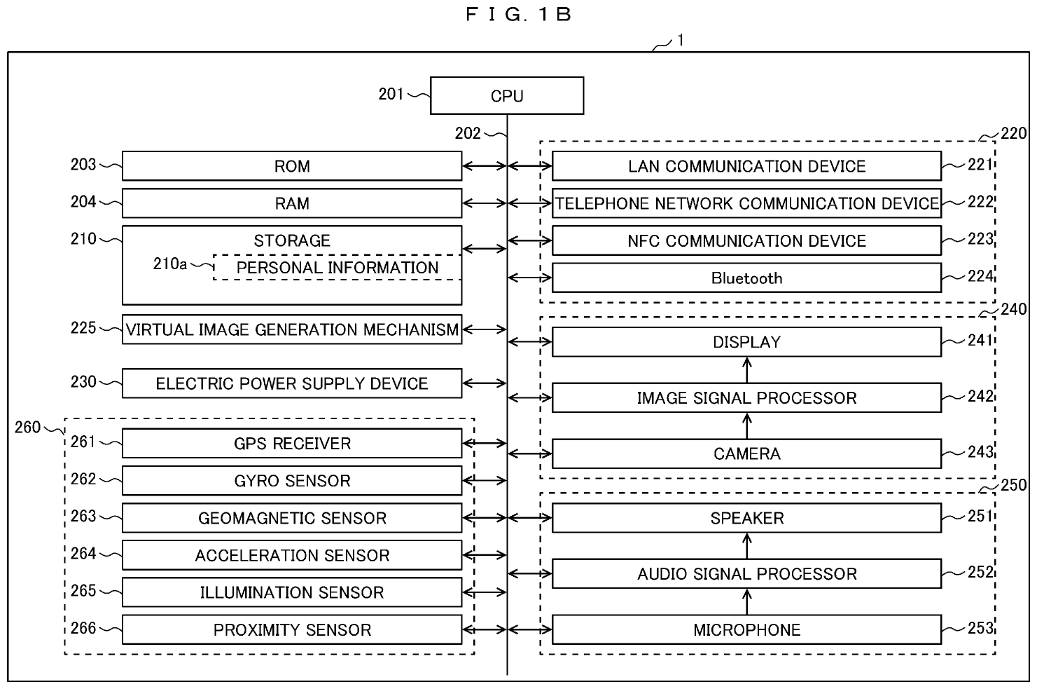

FIG. 1A is a block diagram of the HMD in this example. In FIG. 1A, The HMD includes virtual image generation unit 101, control unit 102, image signal processing unit 103, electric power supply unit 104, memory unit 105, sensing unit 106, communication unit 107, audio processing unit 108, imaging unit 109, and input/output units 91-93.

Virtual image generation unit 101 displays augmented reality (AR) or mixed reality (MR) images in the view of the wearer (user) by magnifying and projecting the images generated by the small display unit as imaginary images.

Control unit 102 controls the HMD 1 as a whole, and its function is realized by an arithmetic device such as a CPU, etc. Image signal processing unit 103 supplies image signals used for display to the display unit in the virtual image generation unit 101. Electric power supply unit 104 supplies electric power to each part of HMD 1.

Memory unit 105 stores data necessary for processing in each part of HMD 1 and data generated in each part of HMD 1. Also, memory unit 105 stores programs and data to be executed by the CPU when the functions of control unit 102 are realized by the CPU. Memory unit 105 is configured by HDD (Hard Disk Drive), SSD (Solid State Drive), or other storage devices.

Sensing unit 106 is connected to various sensors via input/output unit 91, which is a connector, and detects the posture of HMD 1 (i.e., user posture, user head orientation), motion, ambient temperature, etc. based on signals detected by the various sensors. As various sensors, for example, a tilt sensor, acceleration sensor, temperature sensor, GPS (Global Positioning System) sensor to detect the user's position data, etc. are connected.

Communication unit 107 communicates with external data processing devices by short-range wireless communication, long-range wireless communication, or wired communication via input/output unit 92, which is a connector. Specifically, communication is performed via Bluetooth (registered trademark), Wi-Fi (registered trademark), mobile communication networks, universal serial bus (USB, registered trademark), high-definition multimedia interface (HDMI (registered trademark)), etc.

Audio processing unit 108 is connected to audio input/output devices such as microphones, earphones, and speakers via input/output unit 93, which is a connector, to input or output audio signals. Imaging unit 109 is, for example, a small camera or a small TOF (Time Of Flight) sensor, takes a picture of view direction of HMD 1 user.

FIG. 1B shows an example of the hardware configuration of HMD 1. As shown in FIG. 1B, HMD 1 comprises a CPU 201, a system bus 202, a ROM (Read Only Memory) 203, a RAM 204, a storage 210, a communication processing apparatus 220, an electric power supply device 230, a video processor 240, an audio processor 250, and a sensor 260.

CPU 201 is a microprocessor unit that controls the entire HMD 1. CPU 201 corresponds to control unit 102. The system bus 202 is a data communication path for sending and receiving data between the CPU 201 and each operating block in the HMD 1.

ROM 203 is a memory in which basic operating programs such as an operating system and other operating programs are stored, can be used a rewritable ROM, such as EEPROM (Electrically Erasable Programmable Read-Only Memory) and flash ROM.

RAM 204 serves as a work area during execution of the basic operating program and other operating programs. ROM 203 and RAM 204 may be an integral part of CPU 201. ROM 203 may also use a portion of the storage area in storage 210, rather than in an independent configuration as shown in FIG. 1B.

Storage 210 stores operating programs and operating settings of data processing device 100, personal information 210a of the user using HMD 1, and other information. Although not specifically exemplified below, storage 210 may also store operating programs downloaded from the network and various data created by the operating programs. Some storage areas of storage 210 may be substituted for some or all of the functions of ROM 203. For example, devices such as flash ROM, SSD, HDD, etc. may be used for storage 210. ROM 203, RAM 204, and storage 210 correspond to memory unit 105. The above operating programs stored in ROM 203 and storage 210 can be updated and functionally extended by executing a download process from each device on the network.

Communication processing apparatus 220 comprises a LAN (Local Area Network) communication device 221, a telephone network communication device 222, an NFC (Near Field Communication) communication device 223, and a BlueTooth communication device 224. Communication processing apparatus 220 corresponds to communication unit 107. In FIG. 1B, communication processing apparatus 220 includes LAN communication device 221, NFC communication device 223, and BlueTooth communication device 224. However, these may be connected as devices external to HMD 1 via input/output unit 92, as described in FIG. 1A. The LAN communication device 221 is connected to a network via an access point and transmits and receives data to and from devices on the network. NFC communication device 223 transmits and receives data wirelessly when the corresponding reader/writer is in close proximity. BlueTooth communication device 224 communicates wirelessly with a nearby data processing device to send and receive data. However, HMD 1 may have a telephone network communication device 222 that transmits and receives calls and data to and from the base station 105 of the mobile telephone communication network.

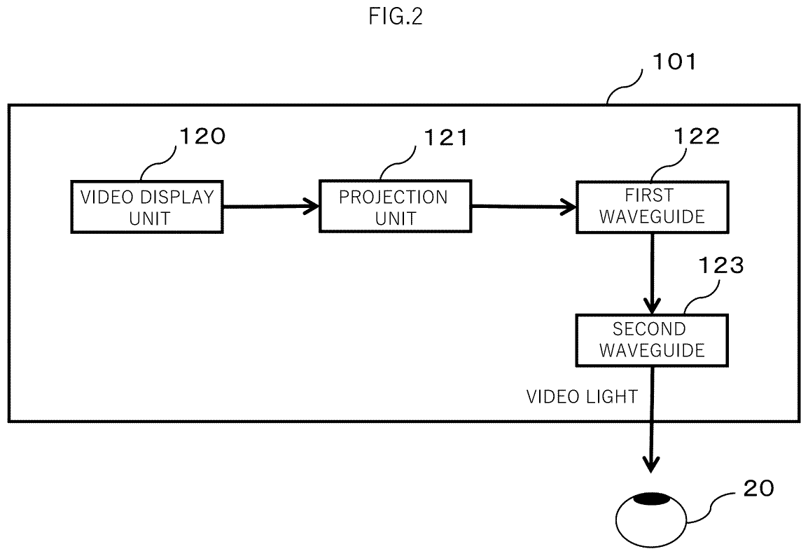

Virtual image generation mechanism 225 has video display unit 120, projection unit 121, first waveguide 122, and second waveguide 123. The virtual image generation mechanism 225 corresponds to virtual image generation unit 101. The specific configuration of the virtual image generation mechanism 225 is described below using FIG. 2.

Electric power supply device 230 is a power supply device that supplies power to HMD 1 in accordance with a specified standard. Electric power supply device 230 corresponds to electric power supply unit 104. FIG. 1B shows an example where electric power supply device 230 is included in HMD 1, but it may be connected as a device external to HMD 1 via any of input/output units 91-93, and HMD 1 may receive power supply from such external device.

Video processor 240 comprises a display 241, an image signal processor 242, and a camera 243. Video processor 240 corresponds to image signal processing unit 103 and virtual image generation unit 101. Also, camera 243 corresponds to imaging unit 109. Display 241 corresponds to the small display unit described above. FIG. 1B illustrates a case in which the video processor 240 includes the display 241 and the camera 243. However, these may be connected as devices external to the HMD 1 via an input/output unit (e.g., input/output unit 93) as described in FIG. 1A.

Display 241 is a display device, for example, a liquid crystal display, digital micromirror device, organic EL display, micro LED display, MEMS (Micro Electro Mechanical Systems), fiber scanning device, displays image data processed by image signal processor 242. Image signal processor 242 displays the input image data on display 241. Camera 243 is camera unit functions as an imaging device that inputs image data of the surroundings and objects, by converting the light input from the lens into electrical signals by using an electronic device such as a CCD (Charge Coupled Device) or CMOS (Complementary Metal Oxide Semiconductor) sensor.

Audio processor 250 comprises a speaker 251, an audio signal processor 252, and a microphone 253. Audio processor 250 corresponds to audio processing unit 108. FIG. 1B shows an example where audio processor 250 includes speaker 251 and microphone 253, but these may be connected as devices external to HMD 1 via input/output unit 93, as described in FIG. 1A.

Speaker 251 outputs audio signals processed by audio signal processor 252. Audio signal processor 252 outputs input audio data to speaker 251. Microphone 253 converts voice into audio data and outputs it to audio signal processor 252.

Sensor 260 is a group of sensors for detecting the status of data processing device 100 and includes a GPS receiver 261, a gyro sensor 262, a geomagnetic sensor 263, an acceleration sensor 264, an illumination sensor 265, and a proximity sensor 266. The sensor 260 corresponds to the sensing unit 106. FIG. 1B illustrates a case in which the sensor 260 includes a GPS receiver 261, a gyro sensor 262, a geomagnetic sensor 263, an acceleration sensor 264, an illumination sensor 265, and a proximity sensor 266. However, as described in FIG. 1A, these may be connected as devices external to the HMD 1 via the input/output unit 91. Since each of these sensors is a conventionally known general sensor group, the description thereof is omitted here. The configuration of HMD 1 shown in FIG. 1B is only an example, and it does not necessarily have to be equipped with all of these.

FIG. 2 is a block diagram of the virtual image generation unit 101 in this example. The virtual image generation unit 101 is configured by a video display unit 120, a projection unit 121, a first waveguide 122, and a second waveguide 123. The video display unit 120 is a device that generates images to be displayed, and irradiates light from a light source such as an LED or laser to a built-in small display unit, which is not shown in the figure. The small display unit is a device for displaying images, and liquid crystal displays, digital micromirror devices, organic EL displays, micro LED displays, MEMS (Micro Electro Mechanical Systems), fiber scanning devices, etc. are used. Projection unit 121 is a device that magnifies the video light from video display unit 120 and projects it as an imaginary image. First waveguide 122 duplicates the video light for eye box magnification. Second waveguide 123 duplicates the video light for eye box enlargement in a different direction from the first waveguide 122 and transmits the video light from the projection unit 121 and the first waveguide 122 to the user's pupil 20. The user can see the video image when the video light is formed on the retina within the pupil 20.

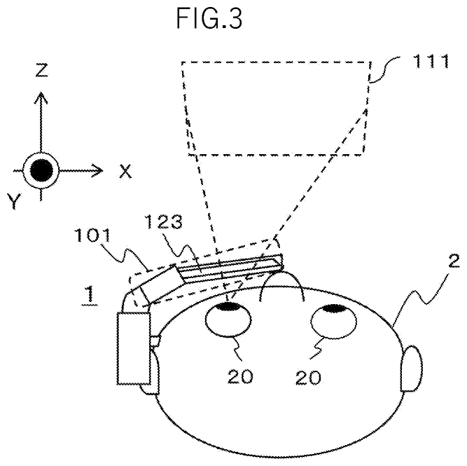

FIG. 3 shows the use configuration of HMD 1 in this example. FIG. 3 shows looking down from the overhead direction of user 2, where the X axis is the horizontal direction, the Y axis is the vertical direction, and the Z axis is the direction of the visual axis. In subsequent drawings, the X, Y, and Z axis directions are defined in the same manner.

HMD 1 is worn on the head of user 2, and the image generated by the virtual image generation unit 101 is propagated to the user's pupil 20 via the second waveguide 123. In this case, the user 2 can see the image (virtual image) in a part of the video display area 111 in the field of view in a state where the outside world is visible (see-through type). Although FIG. 3 shows a configuration in which an image is displayed on one eye, a configuration with both eyes may be used. Also, HMD 1 can capture the range of vision of user 2 in the imaging unit 109 of FIG. 1.

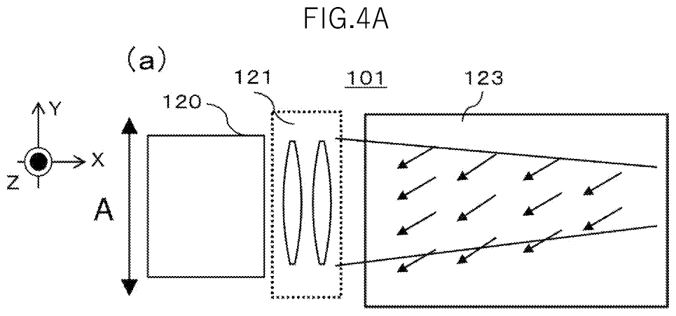

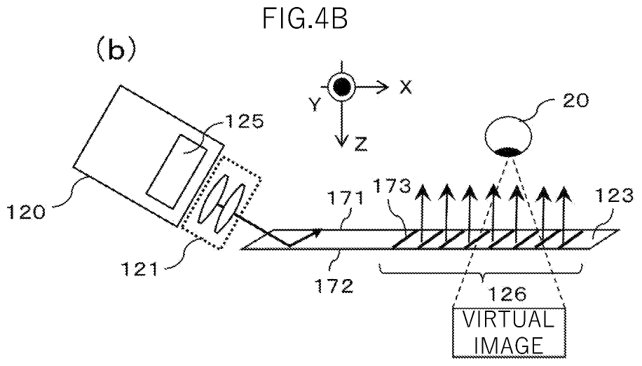

Next, a conventional configuration diagram of a virtual image generation unit 101 using a mirror array type waveguide 123 is shown in FIG. 4. In FIG. 4, (a) (FIG. 4A) shows the virtual image generation unit 101 viewed from the Z-axis direction, which is the visual axis direction. (b) (FIG. 4B) shows the virtual image generation unit 101 viewed from the Y-axis direction, which is the vertical direction. Waveguide 123 is a flat plate with two main parallel planes (171, 172), and has at least two or more partial reflecting surfaces inside (outgoing reflective surface 173) for enlarging the eye box. By the outgoing reflective surface 173, which has a reflective film that reflects a portion of the video light, functions to duplicate the video light of the projection unit 121 in the x-axis direction. Also, it is desirable that the outgoing reflective surface 173 be parallel to each other to prevent angular misalignment of the reflected video light.

The eye box formed by the virtual image generation unit 101 should be expanded in the two-dimensional direction from the viewpoint of practicality. since the waveguide 123 expands the eye box only in the horizontal direction, the optical engine needs to input video light that a large light beam diameter in the vertical direction. Therefore, the F-number of the optical system of the video display unit 120 in the direction needs to be reduced, as a result, the size of dimension A of the video display unit 120 and projection unit 121 in (a) of FIG. 4 are increased, the size of virtual image generation unit 101 is increased. Due to the characteristics of the HMD as a device that is worn on the body, weight and appearance design are also important factors, weight and appearance design are important points in enhancing product value.

Thus, HMD has issue achieving both expanding the eye box in the two-dimensional direction and reducing the size. These solutions are described below.

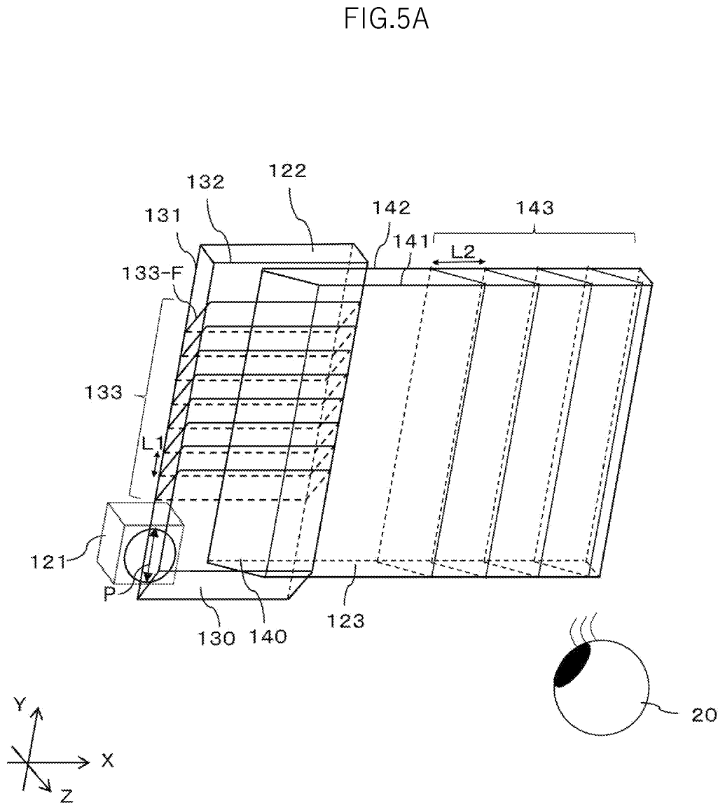

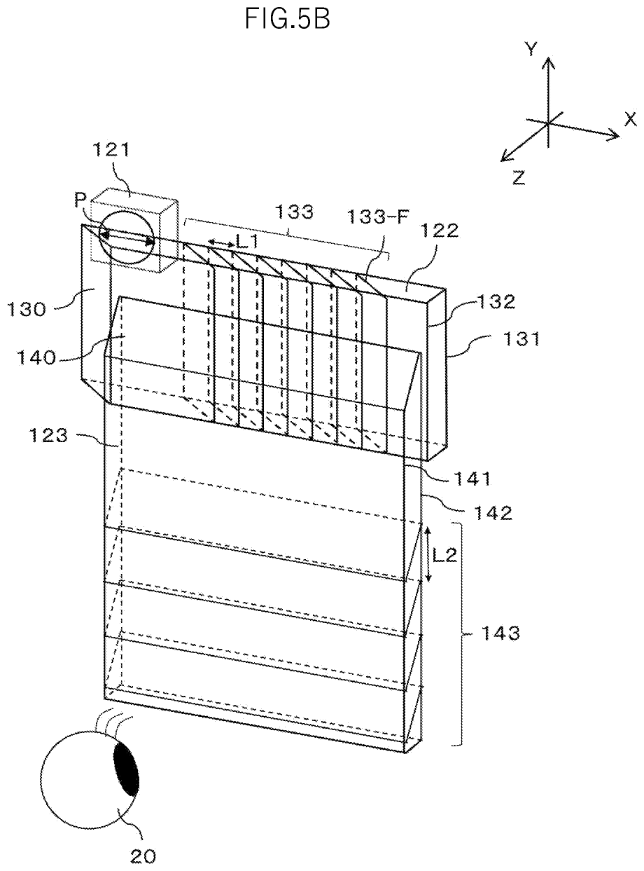

FIG. 5A and FIG. 5B are diagrams of the virtual image generation unit 101 in this example. In FIG. 5A and FIG. 5B, the same configurations as in FIG. 4 are marked with the same symbols and their description is omitted. FIG. 5A and FIG. 5B show the case where the virtual image generation unit 101 is placed on the temporal side and the case where it is placed on the parietal side, respectively. In this example, the first waveguide 122 and second waveguide 123 solve the above issue. As mentioned above, it is desirable that the eye box formed by the virtual image generation unit 101 is expanded in the two-dimensional direction, from the viewpoint of image visibility. To enlarge the eye box in two dimensions, the first waveguide 122 enlarges the vertical direction eye box in FIG. 5A, and enlarges the horizontal direction eye box in FIG. 5B. The first waveguide 122 is a flat plate having an incident surface 130 that reflects the video light into the interior of the first waveguide 122 and two main parallel planes (131, 132) that confine the video light by total reflection resulting in internal reflection, and outgoing reflective surfaces 133 inside, which including two or more outgoing reflective surfaces that output the video light to out of the first waveguide. The distance between adjacent mirrors of the outgoing reflective surfaces 133 is L1. The second waveguide 123 is a flat plate having an input surface 140 (input unit) that reflects the video light into the interior of second waveguide 123, two main parallel planes (141, 142) that confine the video light by total reflection, and outgoing reflective surfaces 143 (output unit) inside, which including two or more outgoing reflective surfaces that output the video light to out of the second waveguide. The distance between adjacent mirrors of the outgoing reflective surface group 143 is L2. The second waveguide 123 emits an image toward the user's pupil 20. Thus, in the virtual image generation unit 101 in this example, the first waveguide 122 and the second waveguide 123 each have a set of parallel main planes that confine the video light by internal reflection, and the first waveguide 122 has an incident surface 130 that reflects the video light to inside and two or more outgoing reflective surfaces that emit the video light to the second waveguide 123. And, the incident surface 130 and the outgoing reflective surface being parallel to each other and at different angles from the main planes. And the second waveguide 123 has the above input unit that combines the video light from the first waveguide 122 into the interior and the above output unit that emits the video light to the user's pupil 20.

In the following, the case in which the internal reflection is total reflection by two parallel planes is illustrated. However, it does not necessarily have to be total reflection. For example, a waveguide with parallel planes that produce normal reflection or diffuse reflection may be used by attaching a film made of a material that transmits or reflects light to some or all of the parallel planes of the waveguide that comprises these parallel planes.

The outgoing reflective surfaces 133 of the first waveguide 122 and the outgoing reflective surfaces 143 of the second waveguide 123 are group of partial reflective surfaces (an example of outgoing reflective surface) that reflect some light and transmit or absorb some light, and the partial reflective surfaces are arranged in an array. By the array direction of the outgoing reflective surfaces 133 of the first waveguide 122 and the array direction of the outgoing reflective surfaces 143 of the second waveguide 123 are different, the two-dimensional expansion of the eye box is realized. Therefore, the lens aperture of the video display unit 120 and projection unit 121 can be reduced (F-number can be increased), and the virtual image generation unit 101 can be made much smaller. In the first waveguide 122 and second waveguide 123, the partial reflective surfaces can be formed by a mirror, and this mirror is sometimes referred to a partial reflective mirror, in the specification.

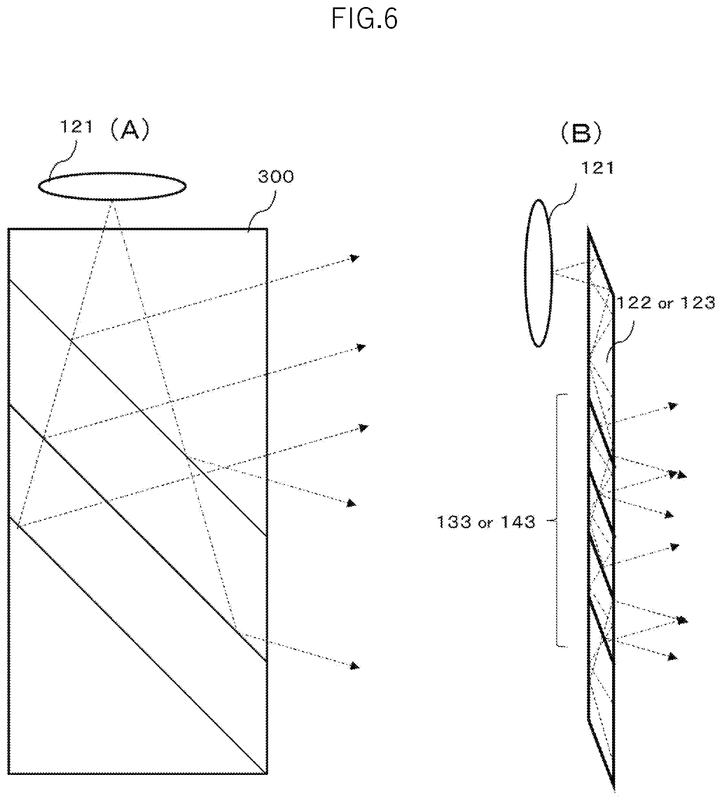

FIG. 6 (A) shows an example of an image light duplication element 300 without function of total reflection confinement. Light rays are emitted from the projection unit 121 at a specified angle of view, but there is a problem that the outer shape becomes large, in order to prevent the generation of stray light on the side surface of the image light duplication element 300. FIG. 6 (B) is the case of first waveguide 122 or second waveguide 123, there is an advantage that reducing the size of the element in order to confine the video light by total reflection while duplicating the video light to enlarge eye box.

The outgoing reflective surfaces 133 of the first waveguide 122 are desirable that parallel to each other to avoid angular misalignment of the reflected image light from the viewpoint of image quality. Thus, the partial reflective surface (outgoing reflective surface) of the outgoing reflective surfaces 133 are desirable that parallel to each other. Similarly, the outgoing reflective surfaces of the second waveguide 123 are desirable parallel to each other. Thus, the partial reflective surface (outgoing reflective surface) of the outgoing reflective surfaces 143 are desirable that parallel to each other. Here, if the parallelism is reduced, the ray angle after reflection at the outgoing reflective surfaces 133 or the outgoing reflective surfaces 143 differs for each reflection surface, degrading image quality by occurring stray light.

If the incident surface 130 of the first waveguide 122 and the outgoing reflective surfaces 133 are also parallel, the processing process can be simplified and manufacturing costs can be reduced. This is because the flat plates with each reflective film are stacked, bonded, and cut out, enabling processing from the incident surface to the outgoing reflective surface in one process, and also making it possible to cut out multiple pieces of first waveguide 122. If the angle of the incident surface 130 is different, it is necessary to cut out the waveguide, after the process of further cutting the incident surface to a predetermined angle, etc. and form the film on the incident surface. By the incident reflective surface 140 of the second waveguide 123 and the outgoing reflective surfaces 143 are parallel as well, it is possible that simplifying the processing and reducing costs.

From the viewpoint of stray light, the video light reflected on the outgoing reflective surfaces 133 of the first waveguide 122 is desirable emitted outside the first waveguide 122 less than or equal to the critical angle at all view angles relative to the main parallel planes (131, 132). This is because if the video light reflected on the outgoing reflective surfaces 133 has a component that exceeds the critical angle and continues to propagate inside the waveguide due to the confinement effect of the waveguide after reflection, this light will be reflected again on the outgoing reflective surfaces 133 and become stray light, output to the second waveguide 123. Similarly, from the viewpoint of avoiding stray light, it is desirable that the video light reflected from the outgoing reflective surfaces 143 of the second waveguide 123 be output to the outside of the second waveguide 123 at a critical angle or less at all view angles to the main parallel planes (141 and 142).

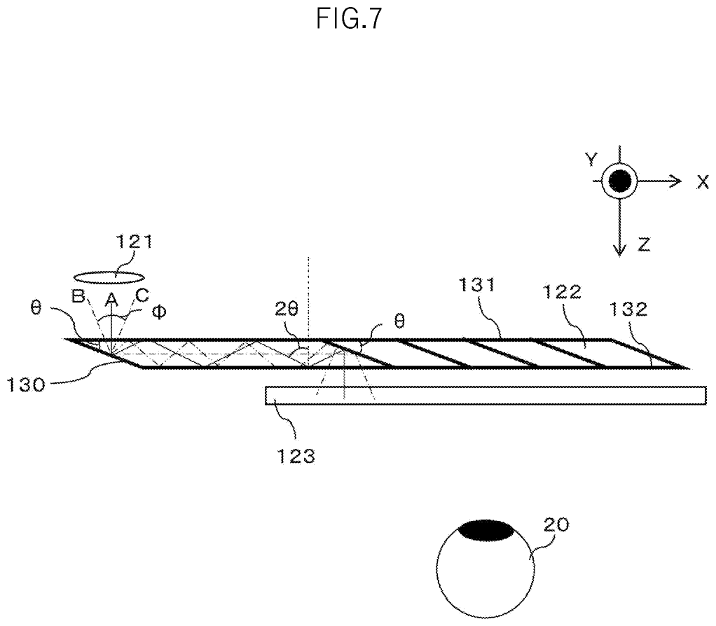

More detailed geometric conditions for the tilt angle θ of the outgoing reflective surface and the total reflection critical angle are described below. The output reflective surface of the outgoing reflective surfaces 133 has a predetermined inclination angle θ with respect to the main planes (131, 132) which are parallel planes in order to change the direction to output the video light to the outside of the waveguide. In FIG. 7, the solid line (A) represents the ray at the center of the angle of view, and the dotted line (B) and double dotted line (C) represent the ray at the edge of the angle of view. The ray A at the center of the angle of view, after being reflected at the incidence surface 130, needs to travel at an angle of incidence of 2θ with respect to the parallel planes 131 and 132. Also, considering refraction at the incident plane 131, the incident angles of rays B and C to planes 131 and 132 in the waveguide are in the range of ±arcsin [sin (Φ/2)/n] from 2θ. Considering the viewpoint of stray light avoidance, the angle of incidence of ray B to planes 131 and 132 needs to be less than or equal to 2θ+arcsin [sin (Φ/2)/n]<90°. In order to satisfy the total reflection condition, the angle of incidence of light ray C on planes 131 and 132 needs to be less than or equal to 2θ−arcsin [sin (Φ/2)/n]<critical angle. Here, n is the refractive index of the substrate. Usually n is about 1.5. When displaying an angle of view of about Φ30°, the tilt angle θ between the incident surface 130 and the outgoing surfaces 133 is in the range of 16° to 40°.

The same condition needs to be satisfied in second waveguide 123, and the tilt angle θ of the incident reflective surface 140 and the outgoing reflective surfaces 143 is in the range of 16° to 40°.

As described above, because the second waveguide 123 receives the video light emitted from the first waveguide 122, as shown in FIG. 5A and FIG. 5B, the main planes (131, 132) of the first waveguide 122 and the main planes (141, 142) of the second waveguide 123 are in different planes, the main planes (131, 132) of the first waveguide 122 are located closer to projection unit 121 than the main planes (141, 142) of the second waveguide 123, and the main planes (131, 132) and main planes (141, 142) that are the two principal parallel planes of each, are arranged in parallel. Also, in order for the incident reflective surface 140 of the second waveguide 123 to efficiently receive the video light emitted from the main surface 132 of the first waveguide 122, the first waveguide 122 and the second waveguide 123 needs to be close together.

The video light in the first waveguide 122 is gradually reflected by the partial reflective surfaces of the outgoing reflective surfaces 133, and proceeds through the interior while reducing the amount of light, and finally all the video light is output to the second waveguide 123 at the final surface 133-F of the outgoing reflective surfaces 133, thereby improving the light utilization efficiency. Therefore, as an example, by configuring the reflectance of the partial reflective surfaces of the outgoing reflective surfaces 133 to gradually increases from the side closer to the incident surface 130 to the final surface 133-F, the light intensity uniformity of the video light within the eye box is improved.

Here, when maintaining the see-through property as a head mounted display, the reflectance of the outgoing reflective surfaces 143 of the second waveguide 123 is lower than that of the outgoing reflective surfaces 133 of the first waveguide 122. In this case, because the reflectance at the outgoing reflective surfaces 143 is low, even if the reflectance of the outgoing reflective surfaces 143 is all the same (i.e., even if the same reflective film is used for each partial reflective surface), it will not be a causing of significant uneven brightness. Rather, since each partial reflective surface can be processed by the same film deposition process, manufacturing costs can be reduced. However, from the viewpoint of ensuring both luminance uniformity and see-through property, it is desirable that the reflectance of the outgoing reflective surfaces 143 of the second waveguide 123 be 10% or less.

On the other hand, if light utilization efficiency is more important than see-through property (i.e., if reflectance is set higher), as an example, by a configuration that the reflectance of the reflective film of the outgoing reflective surfaces 143 gradually increases from side closer to the input surface 140, the light intensity uniformity of video light in the eye box will be improved and image quality will be improved.

If the spacing L1 between adjacent mirrors in the outgoing reflective surfaces 133 of the first waveguide 122 and the spacing L2 between adjacent mirrors in the outgoing reflective surfaces 143 of the second waveguide 123 are wider than the aperture diameter P of the projection lens output section, an eye box area with a small amount of video light is generated by the overlap between adjacent duplicated video light is insufficient. Therefore, by making the spacing L1 and L2 of adjacent reflecting surfaces smaller than the aperture diameter P of the projection unit 121, the luminance uniformity within the visible image and the eye box are improved.

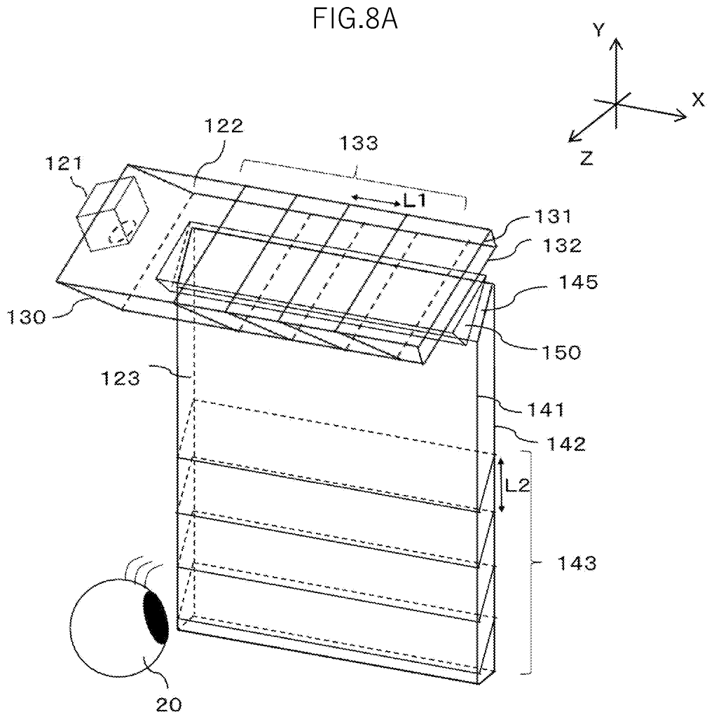

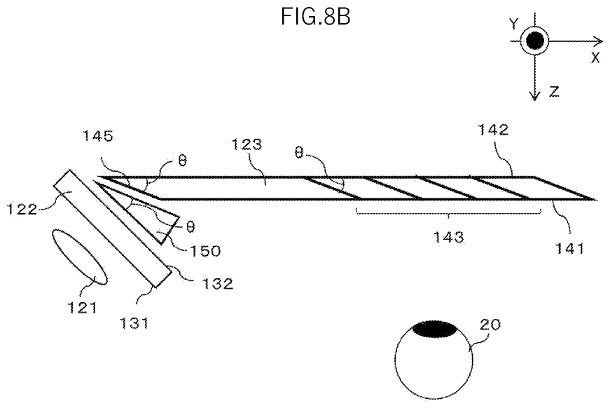

FIG. 8 is modification configuration diagram, shows a variant in which the incident reflective surface 140 of the second waveguide 123 is not a reflective surface but an incident transmissive surface 145 (input unit). FIG. 8A and FIG. 8B respectively shows the case where the virtual image generation unit 101 is arranged on the parietal region side, and the case where it is arranged on the temporal region side. As shown in FIG. 8A, the video light emitted from the first waveguide 122 is input to the incident transmissive surface 145 of the second waveguide 123 through the optical path correction prism 150. According to this configuration, the first waveguide width projected on the Y-axis can be reduced and the portion corresponding to the above dimension A can be apparently reduced, the design property is improved.

As mentioned above, for simplification of processing, the incident transmissive surface 145 and the partial reflective surfaces 143 are parallel, and their tilt angles with respect to the main surfaces (141, 142) are θ each. On the outgoing reflective surface side (i.e., the main surface 132 of the first waveguide 122), the ray angle changes by 2θ relative to the tilt angle θ, whereas on the incident transmissive surface 145, the angle changes by θ, resulting in distortion of the image. Therefore, as shown in FIG. 8A and FIG. 8B, an optical path correction prism 150, whose apex angle has the same θ as the tilt angle, is used to correct the optical path. Thus, in FIG. 8, the main planes (131, 132) of first waveguide 122 are arranged, tilted by 2θ with respect to the main planes (141, 142) of second waveguide 123. As mentioned above, the tilt angle θ ranges from 16° to 40° from viewpoint of stray light.

HMD is highly demanded for eyeglass-shaped design. the configuration of FIG. 8A and FIG. 8B, by the video display unit 120 and the projection unit 121 are tilted together with the first waveguide 122, it can make easy to place the second waveguide 123 between the first waveguide 122 and the user's pupil 20, there is also the advantage that it is easy to design an HMD in the shape of eyeglasses.

As described above, this example provides an HMD that achieves both of the miniaturization of the optical system and the expansion of the eye box.

### Example 2

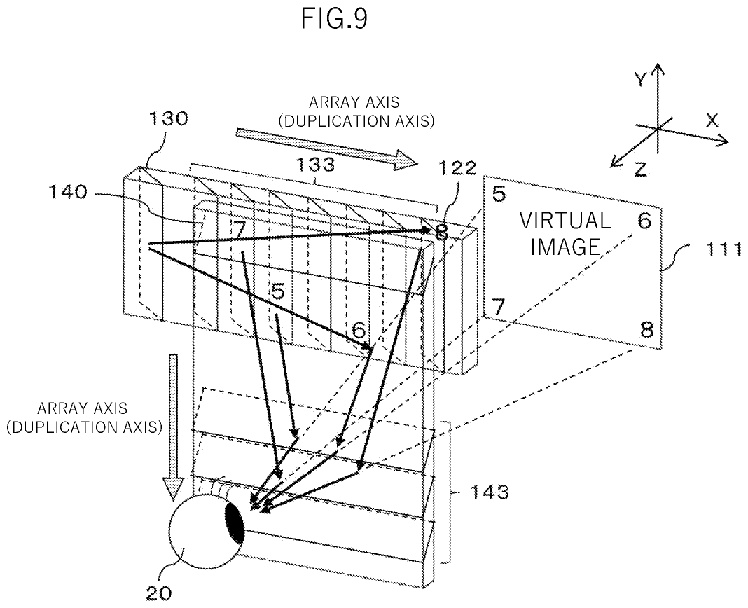

FIG. 9 shows the light path with arrows, when the waveguide in Example 1 is combined with the projection unit 121 that displays images with a wide angle of view. The video light with a given angle of view input to the incident surface 130 of the first waveguide 122 has a different direction of propagation in the waveguide at each angle of view, so the position at which it is output from the outgoing reflective surfaces 133 to the second waveguide 123 is different. In particular, video light emitted from the final surface 133-F, which is farthest from the incident surface 130, has a significantly different output position depending on the angle of view. Wider the angle of view of the video light, the greater the amount of divergence in the output position. Therefore, if vignetting of these video lights is to be avoided, for example, the Y-axis direction of the waveguide may increase in the arrangement of FIG. 9, the size of the element may increase, which increases the cost of element manufacturing, and the dimensions of the HMD may increase, which reduces the designability of the wearable device.

An even greater issue is that the finite size of the incident reflective surface 140 of the second waveguide 123 makes coupling difficult, resulting in reduced image luminance uniformity and light-utilization efficiency. In FIG. 9, arrows indicate rough light paths of the four corner angles of view of the displayed image (virtual image). The angle of view output from the outgoing reflective surface 133, which is farther from the incident plane 130 (even in the virtual image, it is on the far side from the incident surface 130, angle of view 8 and angle of view 6 in the arrangement shown in FIG. 9), is output from the outgoing reflective surface 133, which is farther from the incident plane 130 in the first waveguide 122, thus the amount of deviation of the output position for the incident reflective surface 140 of second waveguide 123 increases, making coupling to second waveguide 123 difficult.

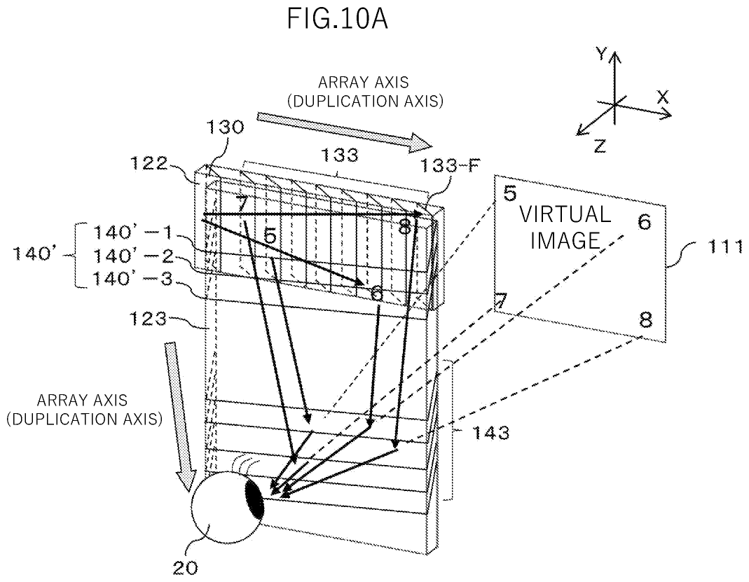

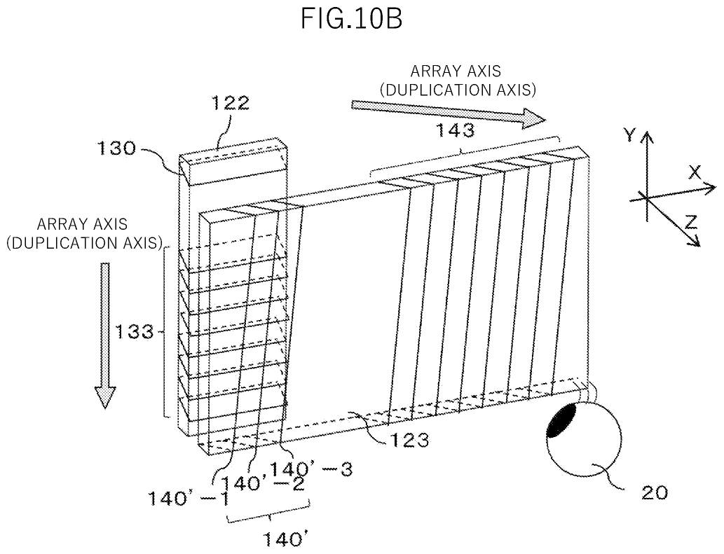

FIG. 10A and FIG. 10B are diagrams of the waveguide in this example. In FIG. 10A and FIG. 10B, the same configurations as in FIG. 5A and FIG. 5B are marked with the same symbols and their description is omitted. FIG. 10A and FIG. 10B show the case where the virtual image generation unit 101 is placed on the temporal side and the case where it is placed on the parietal side, respectively. FIG. 10A and FIG. 10B differ from FIG. 5A and FIG. 5B in that the second waveguide 123 has multiple incident reflective surfaces 140, and the orientation and arrangement direction of the incident reflective surfaces 140 and outgoing reflective surfaces 143.

The configuration of second waveguide 123 in this example is described. As mentioned above, video light propagates in the first waveguide 122 with a spread according to the angle of view and is emitted from each of the outgoing reflective surfaces 133. Therefore, the incident surface 140 of the second waveguide 123, which combines the video light from the first waveguide 122, also needs to have a certain width. Here, if the waveguide is made thicker to increase the area of the incident surface 140 of the second waveguide 123, the interval of total reflection of the video light confined inside becomes wider, and the outgoing interval of the duplicated video light becomes wider, resulting in uneven brightness. In addition, weight and manufacturing cost will also increase due to the increased thickness.

One method to increase the coupling efficiency of the video light from the first waveguide 122 without increasing the thickness of the second waveguide 123 is to use an incident surface group 140′ with two or more incident surfaces. By providing multiple incident surfaces, the effective area of the incident surface can be increased without increasing the thickness. Here, FIG. 10 shows an example with three incident surfaces from 140′-1 to 140′-3 as the incident surface group 140′. The configuration of the incident surface group 140′ can also be used for the second waveguide 123 shown in FIG. 5 of Example 1 to similarly improve the coupling efficiency of the video light in the periphery of the angle of view.

To maintain the image quality of video light, it is desirable that the planes of the incident surface group 140′ are parallel to each other. The video light reflected from the incident surface 140′-1 need to pass through the surfaces 140′-2 and 140′-3. Therefore, the incident surface 140′-1 has a reflectance close to 100%, and the closer the surface is to the pupil 20, the lower the reflectance and the higher the transmission.

Generally, when a reflective film is formed with dielectric multilayers, the reflectance of s-polarized light is higher. Therefore, the video light propagating through the first waveguide 122 has more p-polarized components as it moves toward the end of the outgoing reflective surfaces 133. When viewed from the incident reflective surfaces 140′ of the second waveguide, the s-polarized component increases toward the end of the outgoing reflective surfaces 133. Therefore, by forming the reflective film of the incident reflective surfaces 140′ of the second waveguide 123 as a film with polarization characteristics, and adjusting the reflectance or transmittance characteristics in response to polarization, the luminance uniformity of the displayed image can be improved.

Above mentioned, the configuration of second waveguide 123 with the incident surfaces 140′ can improve the coupling efficiency at the periphery of the angle of view and increase the luminance uniformity of screen, but the luminance (light utilization efficiency) of the entire screen decreases as the number of reflecting surfaces increases, because unnecessary reflections are also generated. Therefore, it is desirable to minimize the number of the incident surfaces 140′, and for this purpose, it is necessary to reduce the amount of positional deviation of the video light emitted from the first waveguide 122 for each angle of view.

Therefore, in this example, the incident surfaces 140′ and the outgoing reflective surfaces 143 of the second waveguide 123 are rotated by a predetermined angle. By rotating the incident surfaces 140′ and the outgoing reflective surfaces 143, the light path in the second waveguide 123 can also be rotated. This configuration allows the size of the first waveguide 122 to be enlarged and to be rotate the light path in the second waveguide 123 of the angle of view (angle of view 8 and angle of view 6 in the figure) that is a factor the number of reflective surfaces in the incident surfaces 140′ of the second waveguide 123 to be increased. Therefore, this configuration can bring the emit position of the angle of view (angle of view 8 and 6 in the figure) from the first waveguide 122 closer to the incident surface 130 side. Therefore, the size of the first waveguide 122 is downsized and the amount of positional deviation of the video light emitted from the first waveguide 122 for each angle of view is reduced, and the number of reflective surfaces of the incident surfaces 140 of the second waveguide 123 is reduced. This can improve the light utilization efficiency of the second waveguide 123 and reduce the manufacturing cost.

Therefore, if the array direction of the reflective surfaces of the outgoing reflective surfaces 133 of the first waveguide 122 is the first array axis, and the array direction of the incident surfaces 140′ and the reflective surfaces of the outgoing reflective surfaces 143 of the second waveguide 123 is the second array axis, then by setting the angle formed by the first and second array axes to be less than 90°, the size of the first waveguide 122 can be smaller and a number of reflective surfaces of the incident surfaces 140′ of the second waveguide 123 can be reduced.

In other words, since the direction of the array of reflective surfaces of the outgoing reflective surfaces 133 of the first waveguide 122 is also the direction in which the video light is duplicated, this is the first duplication axis. since the direction of array of the reflective surfaces of the incident surfaces 140′ and the outgoing reflective surfaces 143 of the second waveguide 123 is also the direction in which the video light is duplicated, this is the second duplication axis. In this case, the angle formed by the first and second duplication axes be less than 90°, is desirable from the viewpoint of to reduce the size of the first waveguide 122, and to reduce the number of reflective surfaces of the incident surfaces 140′ of the second waveguide 123.

For the video light with the angle of view Φ described above, the angle of rotation of the incident surfaces 140′ and the outgoing surfaces 143 of the second waveguide 123 is Δ (i.e., in this example, the angle to the end face of the second waveguide 123 is Δ), and the refractive index of each waveguide is n. In this case, the condition for the light ray of the above angle of view 8 input from the incident surface not to propagate within the first waveguide to a position farther than pupil 20 is, as an example, Δ<arcsin((sin Φ/2n)/2). Here, assuming that the refractive index n is about 1.5 and the angle of view Φ is in the range of 20° to 60°, it is desirable that the rotation angle Δ is in the range of within 10°. Therefore, a configuration in which the angle formed by the first array axis/duplication axis and the second array axis/duplication axis is between 80° and 90° is desirable.

The tilt angle (i.e., the tilt angle with respect to the main plane) of the outgoing reflective surface of first waveguide 122 and second waveguide 123 is explained. Considering the total reflection critical angle, the condition to avoid inverted images due to total reflection, and the condition that to emit the critical angle is broken from the waveguide after the outgoing surface reflection, the tilt angle θ is in the range of 16° to 40°, as in Example 1.

Also, the configuration in which the second array axis or duplication axis is rotated by the second waveguide 123 has been described as an example. But, the same effect can be obtained by rotating the first array axis or duplication axis of the first waveguide 122, so that the angle formed by the first array axis/duplication axis and the second array axis/duplication axis is less than 90°.

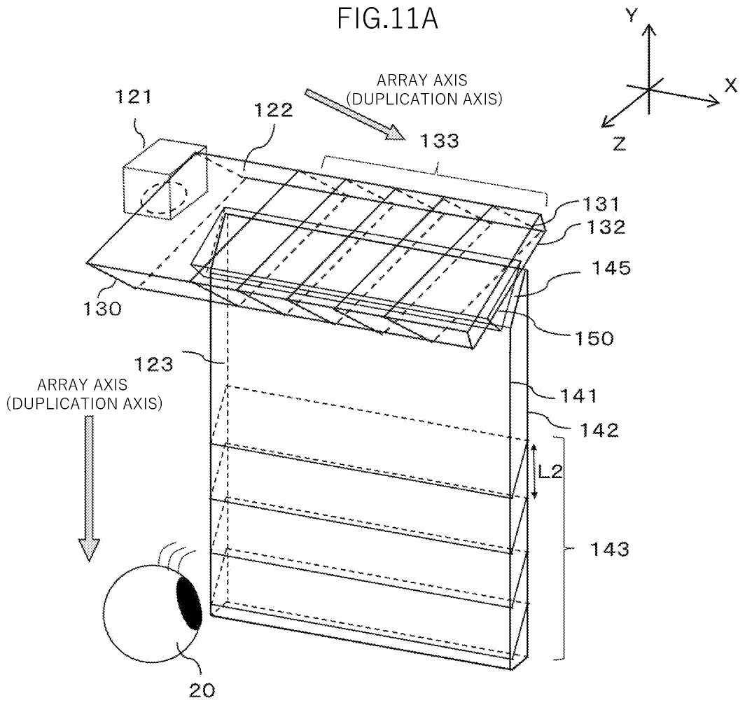

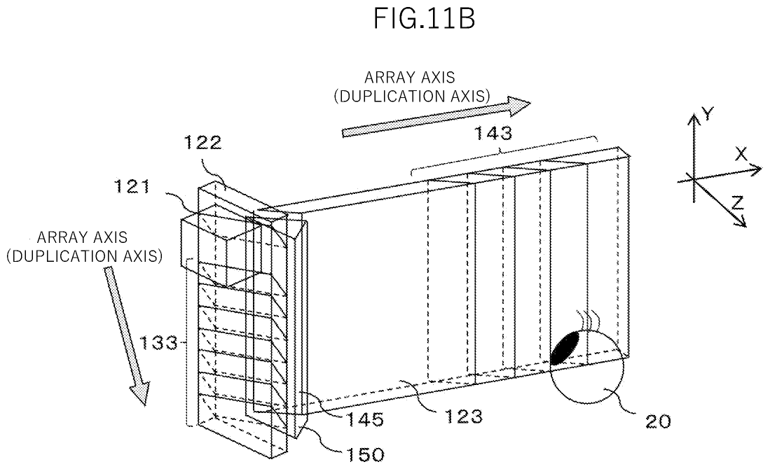

FIG. 11 is a configuration diagram of a variant in which the incident reflective surface 140 of the second waveguide 123 is not a reflective surface but an incident transmissive surface 145. By the incident surface 130 of the first waveguide 122 and the outgoing reflective surface of the outgoing reflective surfaces 133 are rotated, and configure to the angle of the first array axis/duplication axis, which is the projection of the array direction of the outgoing reflective surfaces 133 of the first waveguide 122 onto the xy-plane or the main plane of the second waveguide 123, and the second array axis/duplication axis, which is the array direction of the reflective surface of the outgoing reflective surfaces 143 of the second waveguide 123, are formed less than 90°, the coupling efficiency of video light coupled from the first waveguide 122 to the second waveguide 123 in a region far from the incident surface 130 is increased. FIG. 11A and FIG. 11B respectively shows the case where the virtual image generation unit 101 is arranged on the parietal region side, and the case where it is arranged on the temporal region side. As shown in FIG. 8 and FIG. 11, video light emitted from the first waveguide 122 is input to the incident transmissive surface 145 of the second waveguide 123 through the optical path correction prism 150. According to this configuration, the width of the first waveguide projected on the Y-axis can be reduced, and the portion corresponding to the above dimension A can be apparently reduced, thereby improving the design. In FIG. 11, the configuration in which the first array axis or duplication axis is rotated by the first waveguide 122 has been described as an example. However, by the second array axis or duplication axis of the second waveguide 123 are rotated, and configure to the angle of the first array axis/duplication axis and the second array axis/duplication axis is less than 90°, the same effect can be obtained.

As mentioned above, in terms of processing simplicity, the incident transmissive surface 145 and the group of partial reflective surfaces 143 are parallel, and the tilt angle with respect to the main planes (141, 142) is θ for each of them. On the outgoing reflective surface side (i.e., main plane 131), the ray angle changes by 2θ with respect to the tilt angle θ, whereas on the incident transmissive surface 145, the change is for θ, occurring in distortion of the image. Therefore, as shown in FIG. 11A and FIG. 11B, the light path is corrected by an optical path correction prism 150 whose apex angle has the same θ as the tilt angle. Therefore, in FIG. 11, the main plane (132) of the first waveguide 122 is arranged, tilted by 2θ with respect to the main planes (141, 142) of the second waveguide 123. As mentioned above, the tilt angle θ ranges from 16° to 40° in terms of stray light.

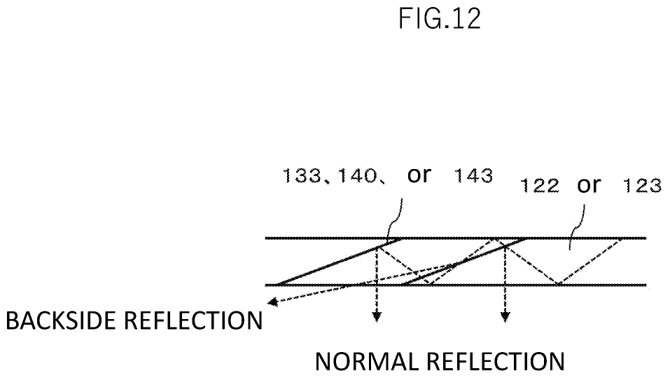

FIG. 12 is a schematic diagram showing the incidence and reflection of light rays on the reflective surfaces in the first waveguide 122 and second waveguide 123. The video light with a specified angle of view in the first waveguide 122 and second waveguide 123 enters the outgoing surfaces within a specified angle range, and output outside the waveguide (normal reflection). On the other hand, since the light rays are confined within the waveguide, a state (backside reflection) occurs in which light is incident from the back surface of the reflective surfaces (133, 140, 143) and reflected light is generated. This backside reflection is an unwanted reflection and is a cause of stray light generation and reduced efficiency.

From the geometric arrangement, the angle of incidence to the reflective surface of the outgoing reflective surfaces (133, 143) is θ±arcsin [sin (Φ/2)/n] when it is normal reflection and 3θ±arcsin [sin (Φ/2)/n] when it is back reflection. Therefore, it is ideal to form a reflective film that suppresses backside reflection in the angle region where the angle of incidence is larger than the angle region of normal reflection to reduce stray light and improve the light utilization efficiency of the waveguide.

However, in general, when reflective films are formed with dielectric multilayers, rays with large incident angles tend to have large reflectance, and if the film structure is complicated to suppress this, the total number of film increases and manufacturing costs rise.

Rays on the larger side of the angle of incidence within the angular range of backside reflection are output from first waveguide 122 between the plane of incidence (130) and pupil 20 (in the example illustrated in FIG. 9, the corresponding rays are from angles of view 5 and 7). Similar rays are also output from the incident plane (140) to the pupil in the second waveguide 123 (in the example illustrated in FIG. 9, the corresponding rays are from angles of view 5 and 6). Here, even if the reflectance of backside reflection is increased for the light output in the first half of the outgoing surfaces (133) and the light to be coupled to the pupil 20 in the first half of outgoing surfaces (143), the effect of light utilization efficiency, uneven luminance, etc. is small.

Therefore, even if there is an area higher than the reflectance in the angular range of normal reflection in the reflectance characteristic on the side with a large incident angle within the angular range of backside reflection, the structure and total number of dielectric multilayer films can be simplified without significantly affecting the image quality, and the manufacturing cost can be suppressed. In particular, the effect is small in the range up to the center of the angle of view, and even if there is an area higher than the reflectance in the angular range of normal reflection in the reflectance on the side where the incident angle is large from the center within the angle range of the backside reflection, the structure of the dielectric multilayer film and the total number of films can be simplified without significantly affecting the image quality, and the manufacturing cost can be reduced.

The configuration of the reflective film for backside reflection described so far can be applied to the first and second waveguides in all the examples described so far, to achieve the same effect.

Since the video light incident on the first waveguide 122 propagates at different angles inside the first waveguide 122, the period of total reflection also changes for each angle of view. The angle of view output on the side closer to the incident surface 130 of the first waveguide 122 (angles of view 5 and 7 in the example illustrated in FIG. 9), the larger the angle of incidence to the main planes (131, 132) and the longer the total reflection period. This causes the video light duplication interval to widen, resulting in a decrease in luminance uniformity. Therefore, the luminance uniformity is improved, regarding the spacing of the outgoing reflective surfaces in the outgoing reflective surfaces 133 of first waveguide 122, by setting the spacing of the reflective surfaces closer side to the incident surface 130 narrower than the spacing of the reflective surfaces in the center part of the outgoing reflective surfaces 133. In addition, when the outgoing reflective surfaces of first waveguide 122 are viewed from the user's pupil 20, in the outgoing reflective surfaces 133 of first waveguide 122 closer to the incident surface 130, the spacing between adjacent outgoing reflective surfaces appears wider due to geometric relationships, it is also factor that reduces luminance uniformity. Therefore, from this point of view, the luminance uniformity is also improved in the same way, regarding the spacing of the outgoing reflective surfaces in the outgoing reflective surfaces 133 of first waveguide 122, by setting the spacing of the reflective surfaces closer side to the incident surface 130 narrower than the spacing of the reflective surfaces in the center part of the outgoing reflective surfaces 133.

This is also true for the second waveguide 123, where the video light incident on the second waveguide 123 propagates at different angles inside the second waveguide 123, and the period of total reflection also changes for each angle of view. The angle of view output on the side closer to the incident surface 140 of the second waveguide 123 (angles of view 5 and 6 in the example illustrated), the larger the angle of incidence to the main planes (141, 142) and the longer the total reflection period. This causes the video light duplication interval to widen, resulting in a decrease in luminance uniformity. Therefore, the luminance uniformity is improved, regarding the spacing of the outgoing reflective surfaces 143 of second waveguide 122, by setting the spacing of the reflective surfaces closer side to the incident surface 140 narrower than the center part of the outgoing reflective surfaces 143. In addition, when the outgoing reflective surfaces of second waveguide 123 are viewed from the user's pupil 20, in the outgoing reflective surfaces 143 of second waveguide 123 closer to the incident surface 140, the spacing between adjacent outgoing reflective surfaces appears wider due to geometric relationships, it is also factor that reduces luminance uniformity. Therefore, from this point of view, the luminance uniformity is also improved in the same way, regarding the spacing of the outgoing reflective surfaces in the outgoing reflective surfaces 143 of second waveguide 123, by setting the spacing of the reflective surfaces closer side to the incident surface 140 narrower than the spacing of the reflective surfaces in the center part of the outgoing reflective surfaces 143.

With respect to the geometrical arrangement of the first waveguide 122 and the second waveguide 123 from the projection unit 121 to the user pupil 20, the main planes of said first waveguide 122, the second waveguide 123, are roughly parallel to each other, and the main planes (131, 132) of the first waveguide 122 and the main planes (141, 142) of the second waveguide 123 are in different planes. The main surface (131, 132) of the first waveguide 122 is arranged closer to the projection unit 121 than the main planes (141, 142) of the second waveguide 123.

Normally, in order to confine video light with a wide angle of view within a waveguide, it is need to that increasing the angular range of light rays that can be confined, by raising the refractive index of the substrate material, and reducing the critical angle of total reflection.

When a microdisplay is used for the video display unit 120, the aperture diameter P of the projection unit 121 is about 3 to 6 mm, and to efficiently receive video light, it is desirable that the size of the incident reflective surface 130 and the incident reflective surfaces 140′ is also about 3 to 6 mm. When the video display unit 120 is a laser scanning type such as a MEMS or fiber scanning device, the beam diameter is small and the projection unit aperture diameter P is as small as ˜2 mm, so the size of the incident reflective surface 130 and the incident reflective surfaces 140′ can also be reduced, and the thickness of the first waveguide 122 and the second waveguide 123 is also thinner and the weight increase can be suppressed.

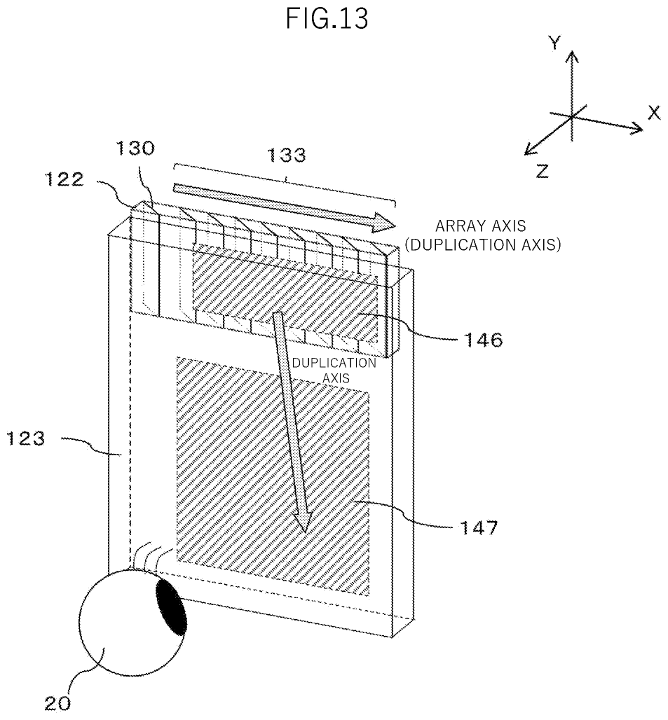

So far, we have described a configuration using mirror arrays for the first waveguide 122 and second waveguide 123, but the eye box may be expanded with a waveguide using a different method. For example, FIG. 13 shows an example of a waveguide using a diffraction grating or a volume hologram for the second waveguide. In the second waveguide 123, input unit 146 is provided. Input unit 146 can be a surface relief diffraction grating or a volume hologram instead of incident reflective surface 140 or input transmissive surface 145, and deflects traveling direction of the input video light, and guides the video light inside of the waveguide. Similarly, the output unit 147 is also formed a surface relief diffraction grating or a volume hologram, and image display while enlarging the eye box is realized by deflecting some of the video light propagated in the waveguide to pupil 20. By the surface relief diffraction grating and volume hologram in the output unit 147 are designed to reduce the diffraction efficiency of the light with respect to the outside world, the second waveguide 123 has see-through property. In this configuration, the angle formed by the first duplication axis, which is the duplication direction of the video light in the first waveguide 122, and the second duplication axis, which is the duplication direction of the video light in the second waveguide, is less than 90°, it is desirable from the viewpoint of size reduction of the first waveguide 122 and improvement of coupling efficiency.

As described above, by the configuration shown in this example, even when video light with a wide angle of view is input, enables high-quality images to be displayed by expanding the eye box while suppressing the increase in the size of the waveguide.

Therefore, according to this example, it is possible to provide an HMD that achieves both downsizing of the optical system and expansion of the eye box while achieving a wide-angle image display.

### Example 3

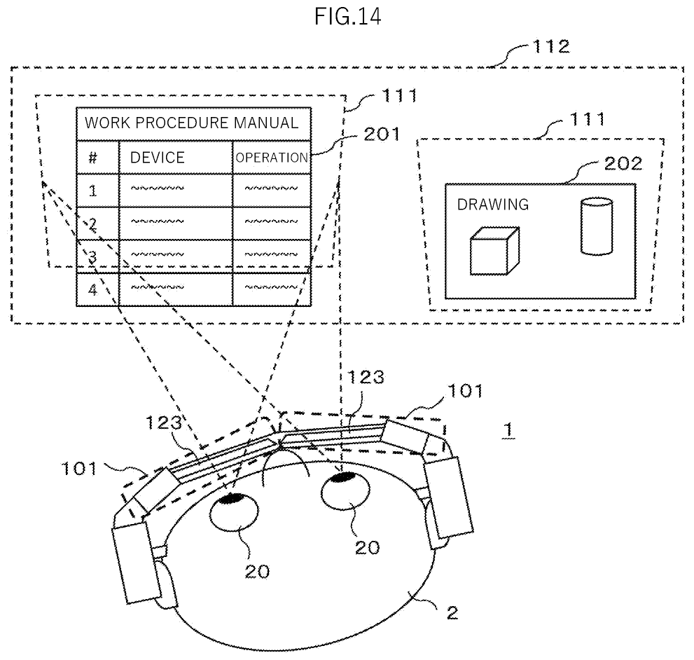

This example describes the application of the HMD described in each example. FIG. 14 shows an example of the use of the HMD in this example.

In FIG. 14, in the field of view of the user 2, Contents are displayed in the visual image (virtual image) display area 111 from the HMD 1. For example, work procedure manual 201 and drawing 202 for inspection and assembly of industrial equipment are displayed. Since the video display area 111 is limited, if work procedure manual 201 and drawing 202 are displayed at the same time, the contents will become smaller and less visible. Therefore, head tracking, which detects the direction of the head of user 2 with an acceleration sensor, is performed and the displayed contents are changed according to the direction of the head to improve the visibility. Thus, in FIG. 14, when user 2 faces left, work procedure manual 201 is displayed in video display area 111, but when the user turns right, drawing 202 is displayed in video display area 111, as if there is a virtual image display area 112 where the work procedure 201 and the drawing 202 can be visually recognized in a wide field of view, it is possible to display.

This improves visibility and allows user 2 to execute work while simultaneously viewing the work object (equipment, tools, etc.) and work instructions, enabling more reliable work and reducing errors.

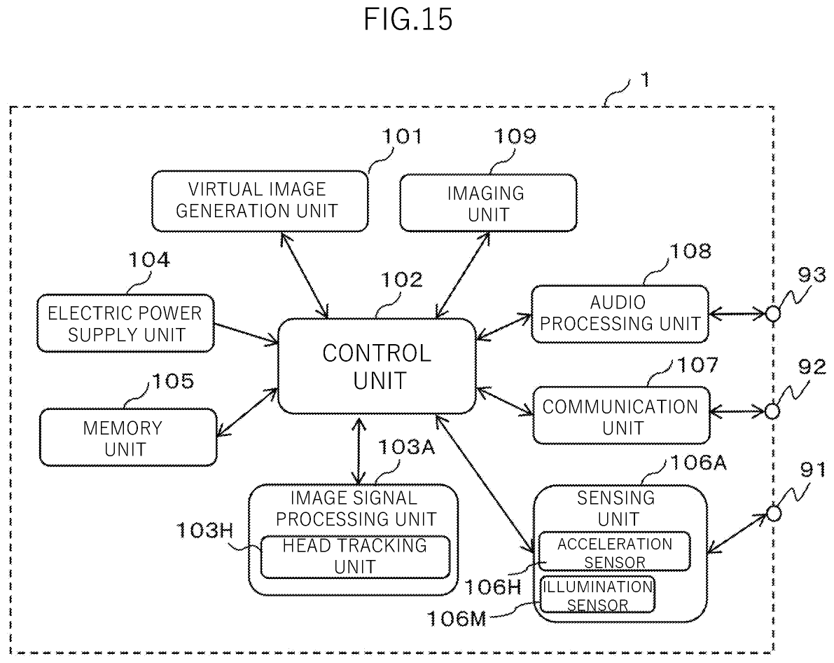

FIG. 15 is a block configuration diagram of the HMD in this example. In FIG. 15, the same components as in FIG. 1 are denoted by the same reference numerals, and descriptions thereof are omitted. In FIG. 15, a different point from FIG. 1 is that a head tracking function is added. Thus, the image signal processing unit 103A of the HMD 1 is provided with a head tracking unit 103H. The head tracking unit 103H detects the direction of the head of the user 2 based on the data from the acceleration sensor 106H of the sensing unit 106A and changes the displayed contents according to the direction of the head.

In addition, HMD are used indoors and outdoors. Therefore, it is necessary to adjust the luminance of the displayed image according to the brightness of the surrounding environment. As an example, the sensing unit 106A can be equipped with an illumination sensor 106M, and the brightness of the image displayed by the image signal processing unit 103A can be adjusted according to the output of the illumination sensor 106M.

Although the examples according to the present invention are described above, the present invention is not limited to the above examples but includes various variations. For example, the functional configuration of the HMD and virtual image generation unit 101 described above is classified according to the main processing contents for ease of understanding. The way the components are classified and their names do not limit the invention. The configuration of the HMD and virtual image generation unit 101 can be further classified into many components depending on the processing content. It can also be classified so that one component performs more processing.

It goes without saying that the invention can be applied not only to HMD but also to other video (virtual image) display apparatuses having the configuration of the virtual image generation unit 101 described in each example.

The angles of rotation of the outgoing reflective surfaces 133, the incident surfaces 140′, and the outgoing reflective surfaces 143 in the case where the angle formed by the first and second duplication axes is less than 90°, as explained above, are examples only and are not limited to the contents (angle values) explained above. The angle formed by the first and second duplication axes may be appropriately formed to be less than 90° without reference to the main plane or end face of the waveguide.

It is also possible to replace part of the configuration of one example with the configuration of another example. It is also possible to add the configuration of one example to the configuration of another example. Also, for a part of the configuration of each example, it is also possible to add/delete/replace other configurations.

### REFERENCE SIGNS LIST

1 Head mounted display (HMD)
101 Virtual image generation unit
102 Control unit
103 Image signal processing unit
104 Electric power supply unit
105 Memory unit
106 Sensing unit
107 Communication unit
108 Audio processing unit
109 Imaging unit
91-93 Input/output unit
111 Video display area
112 Virtual image display area
120 Video display unit
121 Projection unit
122 First waveguide
123 Second waveguide

What is claimed is:

1. A head mounted display that displays image in the user's field of vision, comprising;
a video display unit that generates the image to be displayed,
a first waveguide and a second waveguide that duplicate the video light from the video display unit, and
each of the first waveguide and the second waveguide includes a pair of parallel main planes that confine video light by internal reflection,
the first waveguide includes an incident surface that reflects video light into the inside and two or more outgoing reflective surfaces that emit video light into the second waveguide, and
the second waveguide includes an input unit that couples video light from the first waveguide to the inside and an output unit that emits video light to the user's pupil,
wherein the angle between the duplication direction of video light in the first waveguide and the duplication direction of video light in the second waveguide is less than 90°.

2. The head mounted display according to claim 1,
wherein the incident surface and the outgoing reflective surfaces of the first waveguide are parallel to each other and at different angles from the main planes.

3. The head mounted display according to claim 1,
wherein the output unit of the second waveguide is two or more partial reflective mirrors, and
the same reflective film is formed on the two or more partial reflective mirrors.

4. The head mounted display according to claim 1,
wherein the outgoing reflective surface of the first waveguide and the output unit of the second waveguide are partial reflective mirrors,
there is a first incident angle range in which video light of a predetermined angle of view enters and exits the partial reflective mirror normally, and a second incident angle range in which video light enters the partial reflective mirror from the back surface,
the first incident angle range is smaller than the second incident angle range, and
there is a portion higher than the reflectance of the first incident angle range, in the reflectance region of the high angle side from the center of the second incident angle range.

5. The head mounted display according to claim 1,
wherein the input unit of the second waveguide is one or more incident reflective surfaces, and the output unit is a group of outgoing reflective surfaces including two or more outgoing reflective surfaces, and
each of the incident reflective surfaces and the group of outgoing reflective surfaces are parallel to each other and at different angles from the main planes.

6. The head mounted display according to claim 1,
wherein the angle between the array deletion axis of the outgoing reflective surfaces of the first waveguide and the array deletion axis of the outgoing reflective surfaces of the second waveguide is less than 90°.

7. The head mounted display according to claim 1,
wherein the reflectance of the outgoing reflective surface of the first waveguide is higher the farther it is from the incident surface, and
the reflective surfaces spacing of the outgoing reflective surfaces of the first waveguide and the reflective surfaces spacing of the outgoing reflective surfaces of the second waveguide are smaller than the aperture diameter of the projection unit that projects video light from the video display unit onto the first waveguide.

8. The head mounted display according to claim 1,
wherein the array spacing of the outgoing reflective surfaces located closer to the incident surface is narrower than the array spacing of the outgoing reflective surfaces located in the center part of the first waveguide region.

9. The head mounted display according to claim 1,
wherein the main planes of the first waveguide and the main planes of the second waveguide are parallel,
the main planes of the first waveguide and the main planes of the second waveguide are in different planes, and
the main planes of the first waveguide are positioned closer to the projection unit that projects video light from the video display unit onto the first waveguide than the main planes of the second waveguide.

10. The head mounted display according to claim 1,
wherein the tilt angle of the outgoing reflective surface relative to the main planes of the first and second waveguide is a predetermined angle θ, and
the tilt angle θ is in the range of 16° to 40°.

11. The head mounted display according to claim 1,
wherein the input unit of the second waveguide is one or more incident reflective surfaces with a film with polarization characteristics.

12. The head mounted display according to claim 1,
wherein the input unit of the second waveguide is an incident transmissive surface, and the output unit is a group of outgoing reflective surfaces including two or more outgoing reflective surfaces,
each of the incident transmissive surface and the group of outgoing reflective surfaces are parallel to each other and at a different angle from the main planes,
between the first waveguide and the second waveguide, an optical path correction prism with a vertex angle θ is positioned, and
the main planes of the first waveguide are positioned at a 2θ tilt with respect to the main planes of the second waveguide.

13. The head mounted display according to claim 1,
wherein the input unit of the second waveguide is an incident transmissive surface, and the output unit is a group of outgoing reflective surfaces including two or more outgoing reflective surfaces,
each of the incident transmissive surface and the group of outgoing reflective surfaces are parallel to each other and at a different angle from the main planes, and
the angle between the axis that the duplication direction of video light of the first waveguide projected on the main planes of the second waveguide and the duplication direction of video light of the second waveguide is less than 90°.

14. The head mounted display according to claim 1, further comprising;
an electric power supply unit that supply electricity,
a sensing unit that detects the user's position and posture,
an audio processing unit that inputs or outputs audio signals, and
a control unit that controls the electric power supply unit, the sensing unit, and the audio processing unit.

15. The head mounted display according to claim 1, further comprising;
an acceleration sensor that detects the movement of the user's head,
a head tracking unit that changes the displayed content in response to the user's head movements,
an electric power supply unit that supply electricity,
an audio processing unit that inputs or outputs audio signals, and
a control unit controls the acceleration sensor, the head tracking unit, the electric power supply unit, and the audio processing unit.
